(19) United States
(12) Patent Application Publication
(10) Pub. No.: US 2015/0172855 A1
(43) Pub. Date: Jun. 18, 2015

(54) Applications Using Determined Social Proximity

(71) Applicant: Google Inc., Mountain View, CA (US)

(72) Inventors: Arunesh Mishra, Sunnyvale, CA (US); Christopher Paul Beckmann, San Francisco, CA (US)

(21) Appl. No.: 13/835,368

(22) Filed: Mar. 15, 2013

Related U.S. Application Data
(60) Provisional application No. 61/657,493, filed on Jun. 8, 2012.

(51) Int. Cl. H04W 4/02

(52) U.S. Cl. CPC H04W 4/02

(57) ABSTRACT

Methods, systems and computer program products are provided for activating a feature on a mobile device based on social proximity. Information associated with a first user of a first mobile device and a second user of a second mobile device is received. A degree of spatial proximity between the first device and the second device is estimated based on the received information. When the estimated degree of spatial proximity exceeds a threshold, a degree of social proximity is estimated between the first user and the second user based on the received information. Finally, based on the measure of social proximity, a feature on the first device is activated.

### CROSS REFERENCE TO RELATED APPLICATIONS

This application claims the benefit of U.S. Provisional Patent Application No. 61/657,493, filed Jun. 8, 2012, entitled “Applications Using Determined Social Proximity,” which is incorporated herein in its entirety by reference.

### FIELD

The field relates to mobile applications.

### BACKGROUND

Users enjoy using mobile applications that allow them to share information with other users. Users often attend events with groups of acquaintances and want to quickly share media items with members of the group.

Unfortunately, it is often difficult to share information with specific ad hoc groups of acquaintances. Traditional approaches to automatic sharing either do not consider the actual relationships between users, or require significant manual configuration. Many approaches to sharing information related to a specific event do not automatically consider the people attending the event.

At different times, mobile device users also seek to use mobile device functions to further integrate their group of friends. Mobile devices can be used to help find different group activities, but capturing the preferences of changing groups can be challenging.

### BRIEF SUMMARY

Embodiments described herein relate to activating a feature on a mobile device. According to an embodiment, a method of activating a feature on a mobile device based on social proximity includes receiving information associated with a first user of a first mobile device and a second user of a second mobile device. A degree of spatial proximity is estimated between the first device and the second device based on the received information. When the estimated degree of spatial proximity exceeds a threshold, a degree of social proximity is estimated between the first user and the second user based on the received information. Finally, a feature on the first device is activated based the estimated degree of social proximity.

According to another embodiment, a system for activating a feature on a mobile device based on social proximity includes an information receiver to receive information associated with a first user of a first mobile device and a second user of a second mobile device. A spatial proximity estimator is used to estimate a degree of spatial proximity between the first device and the second device based on the received information. When the estimated degree of spatial proximity exceeds a threshold, a social proximity estimator estimates a degree of social proximity between the first user and the second user based on the received information. Finally, a feature activator activates a feature on the first device based the measure of social proximity.

Further features and advantages, as well as the structure and operation of various embodiments are described in detail below with reference to the accompanying drawings.

### BRIEF DESCRIPTION OF THE FIGURES

Embodiments are described herein with reference to the accompanying drawings. In the drawings, like reference numbers may indicate identical or functionally similar elements. The drawing in which an element first appears is generally indicated by the left-most digit in the corresponding reference number.

FIG. 1 is a block diagram of a network architecture, according to an embodiment.

FIG. 2 is a block diagram of a server, according to an embodiment.

FIG. 3 is a block diagram of a social networking server, calendar server and an email server, according to an embodiment.

FIG. 4 is a diagram that shows a method of activating a feature on a mobile device based on social proximity, according to an embodiment.

FIG. 5 is a block diagram of an example computer system that may be used to implement an embodiment.

### DESCRIPTION OF EMBODIMENTS

The following detailed description of embodiments refers to the accompanying drawings that illustrate embodiments. Other embodiments are possible, and modifications may be made to the embodiments within the spirit and scope of the invention. Therefore, the detailed description is not meant to limit embodiments. Rather, the scope is defined by the appended claims.

The embodiment(s) described and references in the specification to “one embodiment,” “an embodiment,” “an example embodiment,” etc., indicate that the embodiment(s) described may include a particular feature, structure, or characteristic. However, every embodiment may not necessarily include the particular feature, structure or characteristic. Moreover, such phrases are not necessarily referring to the same embodiment. When a particular feature, structure or characteristic is described in connection with an embodiment, it is understood that it is within the knowledge of one skilled in the art to effect such feature, structure, or characteristic in connection with other embodiments, whether or not explicitly described.

It would be apparent to one of skill in the relevant art that the embodiments described below can be implemented in many different embodiments of software, hardware, firmware, and/or the entities illustrated in the figures. Any actual software code with the specialized control of hardware to implement embodiments is not limiting of this description. Thus, the operational behavior of embodiments is described with the understanding that modifications and variations of the embodiments are possible, given the level of detail presented herein.

### Overview of Embodiments

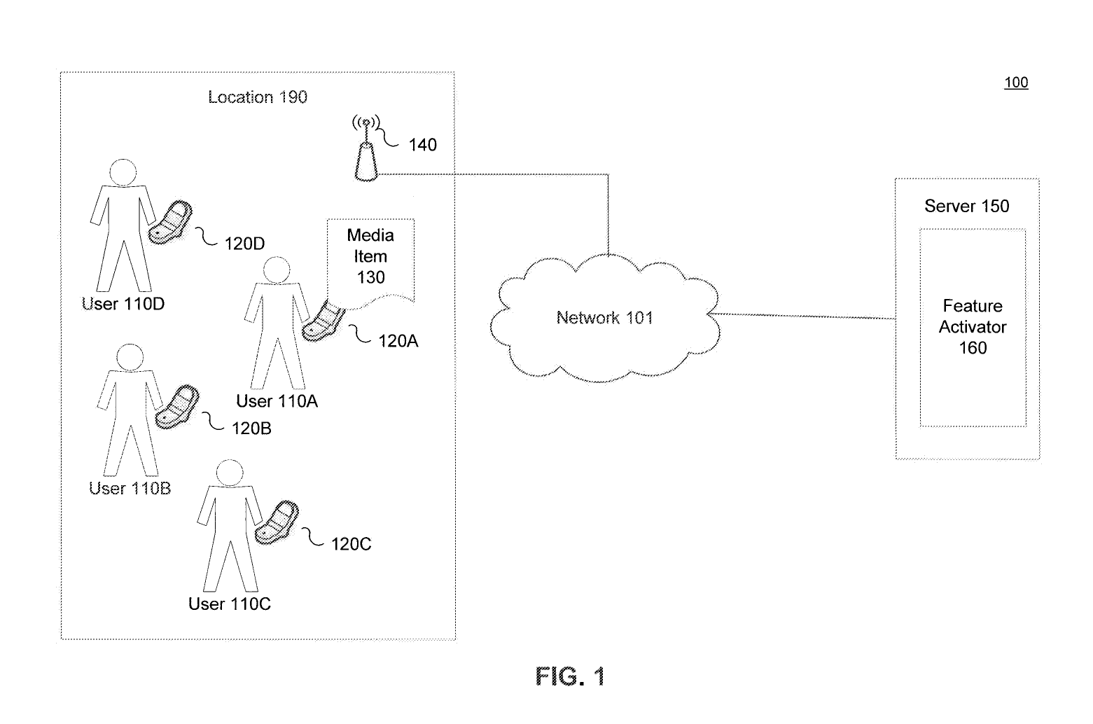

Embodiments described with reference to FIGS. 1-5 below activate a feature on a first mobile device based on determined social proximity between the user of the mobile device and the user of second, spatially proximate mobile device. One approach described herein measures the proximity of nearby mobile devices and, for nearby mobile devices, uses different types of information to estimate the social proximity of associated mobile device users. When a sufficient level of social proximity is estimated, a useful mobile device feature is activated.

An example mobile device feature that can be activated by an embodiment is the transferring of a media item from one device to another. For example, a user at a concert can take a picture with their mobile device, and that picture can be automatically transferred to the mobile devices of their nearby friends. Another feature that can be activated is the automatic request for, and use of, preferences stored on the mobile devices of nearby friends. For example, upon request to suggest a suitable restaurant for a group of friends, an embodiment automatically requests and receives meal preferences from nearby friends and uses these preferences to select suitable restaurants.

FIG. 1 is a block diagram of a network architecture 100 having location 190, network 101 and server 150. Location 190 has users 110A-D, each user having a respective mobile device 120A-D. As used herein, location 190 is a reasonably large indoor or outdoor space, where groups of people can congregate. Mobile devices 120A-D are wirelessly connected to one or more wireless access points 140. Network 101 couples wireless access point 140 to server 150. Server 150 has feature activator 160. Mobile device 120A has media item 130 stored thereon.

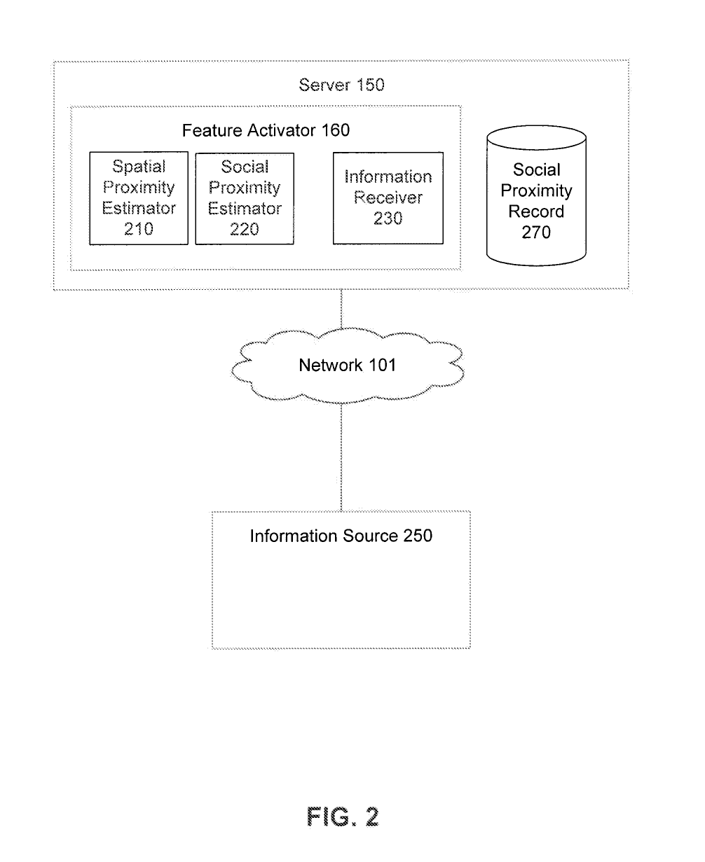

FIG. 2 illustrates server 150 coupled to information source 250 over network 101. Server 150 includes feature activator 160 and social proximity record 270. Feature activator 160 includes spatial proximity estimator 210, social proximity estimator 220 and information receiver 230. The following description of an example operation of feature activator 160 will refer to FIGS. 1 and 2. Spatial proximity estimator 210, social proximity estimator 220 and information receiver 230 are described further below with this example. The approaches described below are illustrative and not intended to limit embodiments. As would be apparent to a person skilled in the art given this description, embodiments that activate a mobile device feature based on determined social proximity can use different approaches.

When user 110A enters location 190, an embodiment detects the presence of users 110B-D at the location. As would be appreciated by one having skill in the relevant art(s), given the description herein, many approaches exist to determine the presence of mobile devices in location 190.

In one embodiment, by using a mobile application running on each mobile device 120A-D, each mobile device can wirelessly communicate their presence to other devices. In another embodiment, mobile devices 120A-D can check-in their locations with a central tracker (not shown) on server 150. Depending on whether location 190 is an indoor or outdoor space, different approaches can be used to estimate a geographic location of mobile devices 120A-D.

In one approach, when a geographic location for mobile devices 120A-D is estimated, the spatial proximity of each mobile device 120B-D to mobile device 120A is estimated. Once each geographic location is determined a spatial proximity of mobile devices 120B-D to mobile device 120A can be estimated.

Another approach to estimating spatial proximity can use characteristics of measured signals to estimate the spatial proximity between two mobile devices, e.g., measured WiFi signals.

A threshold is applied to select only potentially associated users with sufficient spatial proximity. In some embodiments, a threshold is set that selects as potential acquaintances users with mobile devices that are within a specific distance from mobile device 120A. As noted above, a benefit of some embodiments is that a group of acquaintances can be identified that are currently sharing the same experience. Without the application of a threshold, users detected at location 190, but not within a close spatial proximity to 120A, could be erroneously presumed to be a group of acquaintances sharing an event.

In an embodiment, the threshold applied to select potentially associated users can be dynamic, that is, can be modified over time based on characteristics of the environment around the mobile device. Different characteristics of the environment can be measured or estimated. Average entropy and noise in the ambient environment can be used by an embodiment to modify the dynamic threshold over time. For example, measured or estimated interference from people moving around, and other radio frequency (RF) devices such as microwaves, can be measured used to adjust thresholds applied.

By modifying the threshold over time to better reflect the positions of different users, the raw physical proximity metric computed at the radio layer can be incrementally adjusted to increase the accuracy of estimated locations.

One approach to modifying the threshold used by an embodiment uses a learning system. This learning system can adapt over time based on measured ambience characteristics. Ambient characteristics can be measured directly or estimated by an embodiment.

In an example, a spatial proximity threshold is set to 20 feet, and because user 110C is beyond this threshold, no additional analysis is performed on the social proximity of user 110C. Different types of events can also have different appropriate thresholds used. At a dinner event, the threshold for being at a particular table is less than being in a group of friends at a concert, for example. As would be appreciated by one having skill in the relevant art(s), given the description herein, other thresholds can be used by different embodiments.

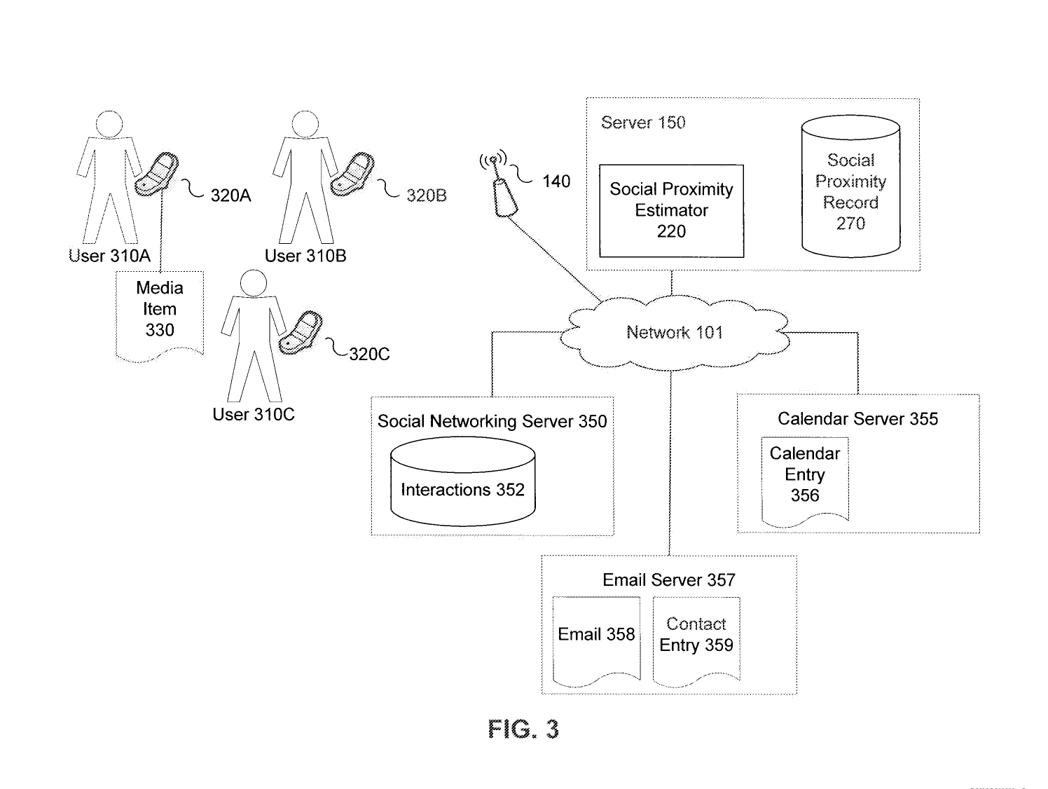

Once the spatial proximity threshold for a mobile device is exceeded, a degree of social proximity between user 110A and users within the spatial proximity is estimated. Broadly speaking, social proximity describes the closeness of the acquaintance between users. As used by some embodiments, this provides a measure with which to assess whether a user would want to have a mobile device function performed with respect to another user. For example, when a user takes a picture media item 130 at an event, an estimated social proximity allows a mobile application to select the users with whom the picture will be shared. Different approaches to estimating the degree of social proximity between user 110A and users within the spatial proximity threshold are described with reference to FIG. 3 below.

Apply threshold to further select only potentially associated users with sufficient social proximity. Applying a threshold corresponding to the level of acquaintance that is sufficient to have a function performed enables an embodiment to limit the activation of certain mobile device functions to people above a particular closeness of the acquaintance. As with the spatial proximity threshold described above, this social proximity threshold can change based on user configuration. Sometimes the thresholding technique can be repeatedly applied to better detect one-time or transient errors in the radio-layer detection.

Based on the estimated high level of social proximity between users 110A and 110B, a feature is activated on mobile device 120A. In this example, a based on the high level of determined social proximity between user 110A and user 110B, feature activator 160 activates a feature on mobile device 120A that transfers media item 130 to mobile device 120B.

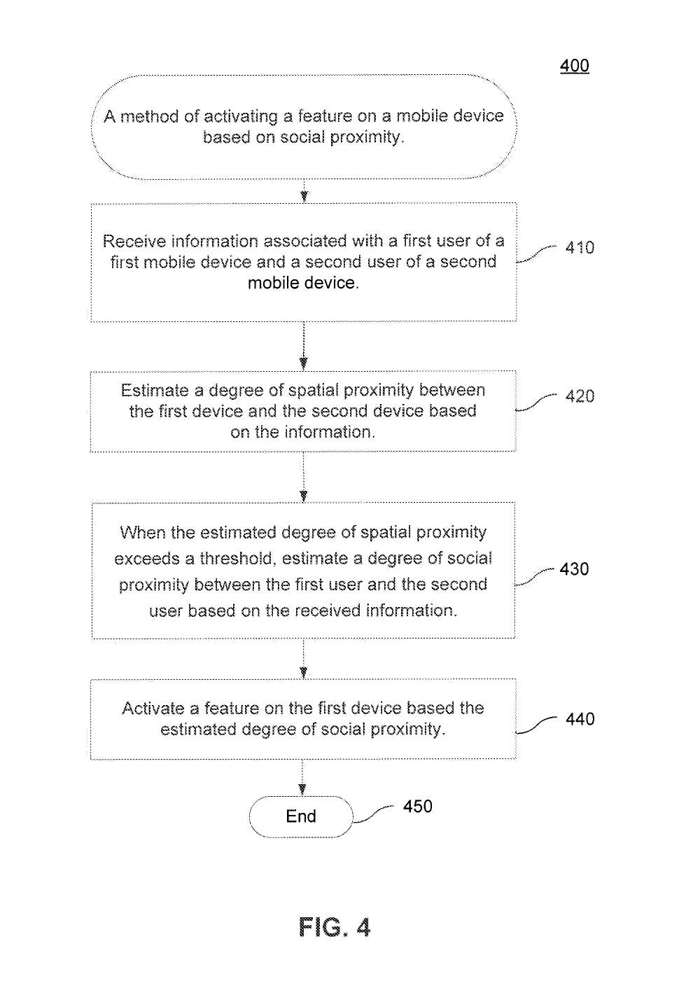

These examples, and the stages of method 400 discussed with respect to FIG. 4 below, are illustrative and not intended to limit the disclosure. As would be apparent to a person skilled in the art given this description, embodiments that activate a mobile device feature based on determined social proximity can have additional or fewer stages.

### Estimating Social Proximity

FIG. 3 shows users 310A-C having respective mobile devices 320A-C. Mobile devices 320A-C are wirelessly coupled to one ore more wireless access points 140, which are coupled to network 101. Network 101 is also coupled to social proximity estimator 220 on server 150, social networking server 350, calendar server 355 and email server 357. User 310A has media item 330 stored in mobile device 320A. Social networking server 350 includes interactions 352, calendar server 355 includes calendar entry 356, and email server 357 includes email 358 and contact entry 359.

In an example shown with respect to FIG. 3, user 310 is at a particular location in a close spatial proximity to users 310B and 310C. User 310A uses mobile device 320A to create media item 330. In this example, users 310A-C are attending a concert, and user 310A creates a picture media item 330 using a camera built in to mobile device 320A. Being at a concert, additional people (not shown) are around user 310A-C.

In this example, users 310A and 310B are acquainted with each other and user 310C is not an acquaintance of user 310A. Each user 310A-C has configured their respective mobile devices 320A-C to use an embodiment described herein. Specifically, user 310A has configured mobile device 320A to send picture media items captured at his location to acquaintances at the same location. Similarly, users 310B-C have configured their respective mobile devices 320B-C to accept picture media items from acquaintances sharing a same location.

After user 310A creates picture media item 330, users 310B-C are detected by an embodiment and, a spatial proximity for each is estimated by spatial proximity estimator 210. The estimated spatial proximity of both users 310B-C is determined to be within the set threshold. As would be appreciated by one having skill in the relevant art(s), given the description herein, in a variation of this embodiment, the process of detecting and assessing users can be performed constantly, not only after media item 330 is created.

Once sufficient spatial proximity of users 310B-C is estimated, the social proximity between user 310A and users 310B-C is estimated according to an embodiment. In estimating the social proximity of users 310B-C, a variety of different factors and sources of information can be used.

In an embodiment, social proximity estimator 220 evaluates one or more of the following factors P1-P4 relevant to social proximity when determining the degree of social proximity between user 310A and user 310B. The degree to which each factor influences estimated social proximity is an implementation specific detail.

P1. Sharing an appointment: Calendar server 355 stores calendar entry 356. In this example, calendar entry is a business meeting with users 310A and 310B as invited participants. Being included in the same calendar entry 356 can indicate a degree of social proximity. The recent character of the calendar entry can also influence this estimate, e.g., an appointment from a year ago can indicate less social proximity than one from the previous week, or one scheduled in the future. The number of attendees in calendar entry 356 can also indicate social proximity, e.g., a meeting with users 310A-B plus one additional attendee can indicate a higher level of social proximity than one with an additional twenty attendees.

P2. Social network interactions: A social networking service provided by social networking server 350 can provide a variety of interactions 352 that can indicate a degree of social proximity between users 310A-C. In this example, user 310A and 310B are linked on social networking server 350, and have several postings on each other's public display portion of the social network interface. These interactions, as well as being members of common interest groups, can all be indicative of social proximity in different embodiments.

P3. Email interactions: Email server 357 can have a variety of useful information that indicates social proximity between users 310A-B. Email 358 is an email that was sent to both users 310A-B, and each may have replied. User 310A can have stored emails on email server 357, some with “favorite” or “flagged” status indicating a special significance to the emails. When user 310A sets particular permissions, an embodiment can use different indications of linkage between users 310A-B to indicate a degree of social proximity.

P4. User Hints: In an embodiment, before a feature is activated with respect to a user with sufficiently socially and spatially proximate status, a confirmation is sent. For example, even after user 310B is determined to have the requisite proximity, but before media item 330 is sent to user 310B, user 310A is notified, and a request is made. In this request, the degree of estimated social proximity of user 310B to user 310A is displayed, and user 310A is requested to confirm. This confirmation can be stored in social proximity record 270, and reused for future estimations of social proximity.

These examples of factors P1-P4 are not intended to limit embodiments. As would be apparent to a person skilled in the art given this description, other factors relevant to social proximity, characteristics and features may be used to analyze social proximity so as to help determine the degree of social proximity between user 310A and users 310C.

### Transitive Social Proximity

In the above example, users 310A-B are estimated to have sufficient spatial and social proximity that media item 330 is shared with user 310B. As noted in the example, users 310A and 310B are acquaintances, as evidenced by a variety of different items of information stored on social networking server 350, calendar server 355 and email server 357.

In the example above, user 310C is not an acquaintance of user 310A. In a variation of this example, user 310C is an acquaintance of user 310B. In a variation of embodiments described herein, in addition to determining a measure of social proximity between users 310A-C, a degree of transitive social proximity between users is also estimated.

In addition to estimating the social proximity between users 310A and users 310B-C, an estimate of the social proximity between users 310B and 310C is also determined. An embodiment of social proximity estimator 220 can use factors similar to factors P1-P4 above to estimate the degree of social proximity between user 310B and user 310C, and thus also estimate the degree of transitive social proximity between user 310A and user 310C. Simply stated, if users 310B and 310C are close enough friends, user 310A may also want to share media item 330 with user 310C when all are attending the same event.

In another example of using transitive social proximity, users 310A-C can have a work-based relationship. Users 310A-C can work for the same firm, in an office building. An embodiment can access an email server 357 operated by the firm, and use information stored thereon to estimate different aspects of social proximity. Users 310A-C can be estimated to have a certain level of social proximity based on their shared employer. Users 310A-C can also be estimated have certain levels of social proximity based on their being assigned to work in the same building, floor and/or office. It should be appreciated that, as used by embodiments, social proximity can encompass personal as well as professional connections.

### Additional Application Features

As described with reference to FIGS. 3 and 4 above, automatic sharing of media item 330 is one example of features that can be activated by embodiments. In another embodiment, automatic determination of a local group can allow for the selection of options based on the preferences of members of the group. For example, when an immediate group of people want to select a restaurant, it can be time consuming to poll members for their food likes and dislikes.

As described with reference to FIGS. 1-3 above, an embodiment can generate a list of spatially and socially proximate people. Based on the estimated degree of social proximity, the feature activated can include requesting food preferences for each group member, and then performing a restaurant search based on these preferences. These food preferences may be predetermined and stored in respective mobile devices 320B-C. When performing the search, mobile device 320A polls mobile devices 320B-C and receives the predetermined preferences.

In some embodiments, based on their higher estimated level of social proximity, certain members of the group may have their preferences preferred over others. For example, if user 310B prefers seafood and user 310C prefers steak, when user 310C has a higher level of social proximity to user 310A, steakhouses are ranked higher on a list of restaurant results. Other similar searches may be performed for movies or concerts acceptable to the determined group of acquaintances.

### Method

FIG. 4 illustrates an exemplary method 400 of activating a feature on a mobile device based on social proximity. As shown in FIG. 4, method 400 begins at stage 410 where information associated with a first user of a first mobile device and a second user of a second mobile device is received. For example, as shown in FIG. 1, information is received at feature activator 160 from mobile devices 120A-D associated with respective users 110A-D. An example of information received from mobile devices 120A-D is location information associated with the geographic positions of mobile devices 120A-D. Once stage 410 is complete, method 400 proceeds to stage 420.

At stage 420, a degree of spatial proximity between the first device and the second device is estimated based on the received information. For example, spatial proximity estimator 210, using the location information received from mobile devices 120A-B, estimates the spatial proximity of each mobile device 120B-D from mobile device 120A. In this example, mobile devices 120B-C are estimated to be 5 feet away from mobile device 120A and mobile device 120D is estimated to be 50 feet away. Once stage 420 is complete method 400 proceeds to stage 430.

At stage 430, when the estimated degree of spatial proximity meets a threshold, a degree of social proximity between the first user and the second user is estimated based on the received information. In this example, the threshold spatial proximity is 20 feet away from user 110A. Based on the distances of mobile devices 120B-D, mobile devices 120B-C, at 5 feet away, are within this threshold spatial proximity. In this example, social proximity estimator 220 estimates the social proximity to user 110A of users 110B-C. User 110B is determined to have a high level of social proximity to user 110A as compared to user 110B. Once stage 430 is complete method 400 proceeds to stage 440.

At stage 440, a feature on the first device is activated based the estimated degree of social proximity. Continuing the example above, based on the high level of determined social proximity between user 110A and user 110B, feature activator 160 activates a feature on mobile device 120A that transfers media item 130 to mobile device 120B. After stage 440, method 400 ends at stage 450.

### Example Computer System Implementation

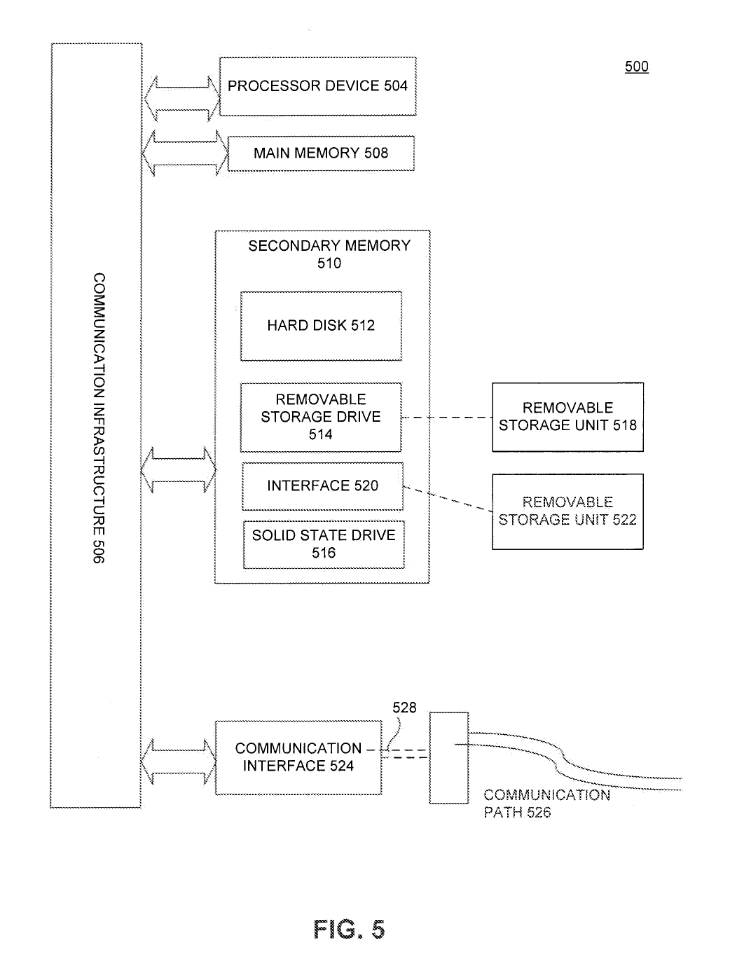

FIG. 5 illustrates an example computer system 500 in which embodiments or portions thereof may be implemented. For example, portions of systems or methods illustrated in FIGS. 1-4 may be implemented in computer system 500 using hardware, software, firmware, tangible computer readable media having instructions stored thereon, or a combination thereof, and may be implemented in one or more computer systems or other processing systems. Hardware, software or any combination of such may embody any of the modules/components in FIGS. 1-3 and any stage in FIG. 4. Mobile devices (120A-D, 320A-C), server 150, social networking server 350, calendar server 355, email server 357 and information source 250, can also be implemented using components of computer system 500.

One of ordinary skill in the art may appreciate that embodiments of the disclosed subject matter can be practiced with various computer system and computer-implemented device configurations, including smartphones, cell phones, mobile phones, tablet PCs, multi-core multiprocessor systems, minicomputers, mainframe computers, computer linked or clustered with distributed functions, as well as pervasive or miniature computers that may be embedded into virtually any device.

Various embodiments are described in terms of this example computer system 500. After reading this description, it will become apparent to a person skilled in the relevant art(s) how to implement embodiments using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

For instance, at least one processor device and a memory may be used to implement the above described embodiments. A processor device may be a single processor, a plurality of processors, or combinations thereof. Processor devices may have one or more processor ‘cores.’ Processor device 504 may be a single processor in a multi-core/multiprocessor system, such system operating alone, or in a cluster of computing devices operating in a cluster or server farm. Processor device 504 is connected to a communication infrastructure 506, for example, a bus, message queue, network or multi-core message-passing scheme.

Computer system 500 also includes a main memory 508, for example, random access memory (RAM), and may also include a secondary memory 510. Secondary memory 510 may include, for example, a hard disk drive 512, removable storage drive 514 and solid state drive 516. Removable storage drive 514 may include a floppy disk drive, a magnetic tape drive, an optical disk drive, a flash memory, or the like. The removable storage drive 514 reads from and/or writes to a removable storage unit 518 in a well known manner. Removable storage unit 518 may include a floppy disk, magnetic tape, optical disk, etc, which is read by and written to by removable storage drive 514. As will be appreciated by persons skilled in the relevant art, removable storage unit 518 includes a computer readable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such storage means may include a program cartridge and cartridge interface (such as that found in video game devices), a removable memory chip (such as an EPROM, or PROM) and associated socket, and other removable storage unit 522 and interface 520 which allow software and data to be transferred from the removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 may be in electronic, electromagnetic, optical, or other forms capable of being received by communications interface 524. This data may be provided to communications interface 524 via a communications path 526. Communications path 526 carries the data and may be implemented using wire or cable, fiber optics, a phone line, a cellular phone link, an RF link or other communications channels.

In this document, the terms “computer program storage medium” and “computer readable storage medium” are used to generally refer to media such as removable storage unit 518, removable storage unit 522, and a hard disk installed in hard disk drive 512. Computer program storage medium and computer readable storage medium may also refer to memories, such as main memory 508 and secondary memory 510, which may be memory semiconductors (e.g., DRAMs, etc.).

Computer programs (also called computer control logic) may be stored in main memory 508 and/or secondary memory 510. Computer programs may also be received via communications interface 524. Such computer programs, when executed, enable computer system 500 to implement embodiments as discussed herein. In particular, the computer programs, when executed, enable processor device 504 to implement the processes of embodiments, such as the stages in the method illustrated by method 400 of FIG. 4 discussed above. Accordingly, such computer programs represent controllers of the computer system 500. Where embodiments are implemented using software, the software may be stored in a computer program product and loaded into computer system 500 using removable storage drive 514, interface 520, hard disk drive 512 or communications interface 524.

Embodiments also may be directed to computer program products comprising software stored on any computer readable medium. Such software, when executed in one or more data processing devices, causes a data processing device(s) to operate as described herein. Embodiments may employ any computer useable or readable medium. Examples of computer readable storage media include, but are not limited to, primary storage devices (e.g., any type of random access memory) and secondary storage devices (e.g., hard drives, floppy disks, CD ROMS, ZIP disks, tapes, magnetic storage devices, and optical storage devices, MEMS, nanotechnological storage device, etc.).

### CONCLUSION

Embodiments described herein relate to methods, system and computer program products for activating a feature on a mobile device based on an estimated social proximity. The summary and abstract sections may set forth one or more but not all example embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

1. A method of activating a feature on a mobile, device based on social proximity, comprising:
receiving information associated with a first user of a first mobile device and a second user of a second mobile device;
estimating a degree of spatial proximity between the first device and the second device based on the received information;
when the estimated degree of spatial proximity is within a spatial proximity threshold, estimating a degree of social proximity between the first user and the second user based on the received information, wherein the spatial proximity threshold comprises a distance; and
when the estimated degree of social proximity meets or exceeds a social proximity threshold, activating a feature on the first device based on the estimated degree of social proximity, wherein the social proximity threshold corresponds to a level of acquaintance sufficient to activate the feature on the first device.

2. The method of claim 1, wherein estimating the degree of social proximity between the first user and the second user is further based on characteristics of the first user and second user received from a storage.

3. The method of claim 2, wherein estimating the degree of social proximity between the first user and the second user based on characteristics received from a storage comprises estimating the degree of social proximity based on a calendar entry associated with the first user and second user.

4. The method of claim 2, wherein estimating the degree of social proximity between the first user and the second user based on characteristics received from a storage comprises estimating the degree of social proximity based on a contact entry associated with the first user and the second user.

5. The method of claim 1, wherein estimating the degree of social proximity between the first user and the second user based on the information comprises estimating the degree of social proximity based on a calendar entry received from one of the first device and the second device associated with the first user and second user.

6. The method of claim 1, wherein estimating the degree of social proximity between the first user and the second user based on the information comprises estimating the degree of social proximity based on a contact entry received from one of the first device and the second device associated with the first user and second user.

7. The method of claim 1, wherein estimating the degree of social proximity between the first user and the second user based on the information comprises estimating the degree of social proximity based on a communication record.

8. The method of claim 1, wherein remotely activating the feature on the first device based on the measure of social proximity comprises remotely activating a feature to send data from the first mobile device to the second mobile device.

9. The method of claim 8, wherein remotely activating a feature to send data from the first device comprises remotely activating a feature to send data from the first device to the second device.

10. The method of claim 8, wherein remotely activating a feature to send data from the first device to the second device comprises remotely activating a feature to send an image from the first device to the second device.

11. A system for activating a mobile device feature based on social proximity, comprising
an information receiver configured to receive information associated with a first user of a first mobile device and a second user of a second mobile device;
a spatial proximity estimator configured to estimate a degree of spatial proximity between the first device and the second device based on the received information;
a social proximity estimator configured to, when the estimated degree of spatial proximity is within a spatial proximity threshold, estimate a degree of social proximity between the first user and the second user based on the received information, wherein the spatial proximity threshold comprises a distance; and
a feature activator configured to, when the estimated degree of social proximity meets or exceeds a social proximity threshold, activate a feature on the first device based on the estimated degree of social proximity.

12. The system of claim 11, wherein the social proximity determiner is configured to estimate the degree of social proximity between the first user and the second user based on characteristics of the first user and second user received from a storage.

13. The system of claim 12, wherein the characteristics of the first user and second user received from the storage comprise a calendar entry associated with the first user and second user.

14. The system of claim 12, wherein the characteristics of the first user and second user received from the storage comprise a contact entry associated with the first user and the second user.

15. The system of claim 12, wherein the characteristics of the first user and second user received from the storage comprise a communication record associated with the first user and second user.

16. The system of claim 11, Wherein the feature activator is configured to activate a feature to send data from the first mobile device to the second mobile device.

17. The system of claim 16, wherein the data to be sent from the first mobile device to the second mobile device comprises an image.

18. A non-transitory computer-readable storage medium having computer-executable instructions stored thereon that, when executed by a computing device, cause the computing device to perform operations for activating a feature on a mobile device based on social proximity, the operations comprising:
receiving information associated with a first user of a first mobile device and a second user of a second mobile device;
estimating a degree of spatial proximity between the first device and the second device based on the received information;
when the estimated degree of spatial proximity is within a spatial proximity threshold, estimating a degree of social proximity between the first user and the second user based on the received information, wherein the spatial proximity threshold comprises a distance; and
when the estimated degree of social proximity meets or exceeds a social proximity threshold, activating a feature on the first device based on the estimated degree of social proximity, wherein the social proximity threshold corresponds to a level of acquaintance sufficient to activate the feature on the first device.

19. The computer-readable storage medium of claim 18, wherein estimating the degree of social proximity between the first user and the second user is further based on characteristics of the first user and second user received from a storage.

20. The computer-readable storage medium of claim 19, wherein estimating the degree of social proximity between the first user and the second user based on characteristics received from a storage comprises estimating the degree of social proximity based on a calendar entry associated with the first user and second user.

21. The computer-readable storage medium of claim 19, wherein estimating the degree of social proximity between the first user and the second user based on characteristics received from a storage comprises estimating the degree of social proximity based on a contact entry associated with the first user and the second user.

22. The computer-readable storage medium of claim 18, wherein estimating the degree of social proximity between the first user and the second user based on the information comprises estimating the degree of social proximity based on a calendar entry received from one of the first device and the second device associated with the first user and second user.

23. The computer-readable storage medium of claim 18, wherein estimating the degree of social proximity between the first user and the second user based on the information comprises estimating the degree of social proximity based on a contact entry received from one of the first device and the second device associated with the first user and second user.

24. The computer-readable storage medium of claim 18, wherein estimating the degree of social proximity between the first user and the second user based on the information comprises estimating the degree of social proximity based on a communication record.

25. The computer-readable storage medium of claim 18, wherein remotely activating the feature on the first device based on the measure of social proximity comprises remotely activating a feature to send data from the first mobile device to the second mobile device.

26. The computer-readable storage medium of claim 25, wherein remotely activating a feature to send data from the first device comprises remotely activating a feature to send data from the first device to the second device.

27. The computer-readable storage medium of claim 25, wherein remotely activating a feature to send data from the first device to the second device comprises remotely activating a feature to send an image from the first device to the second device.
